(19) United States
(12) Patent Application Publication
(10) Pub. No.: US 2020/0341194 A1
(43) Pub. Date: Oct. 29, 2020

(54) Holographic Waveguide Illumination Homogenizers

(71) Applicant: DigiLens Inc., Sunnyvale, CA (US)

(72) Inventors: Jonathan David Waldern, Los Altos Hills, CA (US); Alastair John Grant, San Jose, CA (US); Milan Momcilo Popovich, Leicester (GB)

(73) Assignee: DigiLens Inc., Sunnyvale, CA (US)

(21) Appl. No.: 16/544,732

(22) Filed: Aug. 19, 2019

Related U.S. Application Data
(60) Provisional application No. 62/839,493, filed on Apr. 26, 2019.

(51) Int. Cl. G02B 6/12; G03H 1/32; G03H 1/22; G02B 6/34

(52) U.S. Cl. CPC G02B 6/12016; G03H 1/32; G02B 6/34; G03H 1/2294; G03H 1/2249

(57) ABSTRACT

Systems and methods for holographic waveguide illumination homogenizers in accordance with various embodiments of the invention are illustrated. One embodiment includes an illumination device that includes a laser source emitting light of at least a first wavelength, a light modulator, a dynamic micromirror device for reflecting incident collimated light modulated with image data by said light modulator into directions within a field of view, and at least one waveguide substrate with a first and second total internal reflection surface, each said substrate supporting at least one input grating for coupling light of a first polarization from said laser into a total internal reflection path in said substrate and at least one switchable grating beam splitter for diffracting said first polarization light and receiving light of a second polarization reflected from said dynamic micromirror device and transmitting it through a second surface of the waveguide.

### CROSS-REFERENCE TO RELATED APPLICATIONS

The current application claims the benefit of and priority under 35 U.S.C. § 119(e) to U.S. Provisional Patent Application No. 62/839,493 entitled “Holographic Waveguide Illumination Homogenizer,” filed Apr. 26, 2019. The disclosure of U.S. Provisional Patent Application No. 62/839,493 is hereby incorporated by reference in its entirety for all purposes.

### FIELD OF THE INVENTION

The present disclosure relates to waveguide device for homogenizing laser illumination and more particularly to a holographic waveguide homogenizer.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (“TIR”).

Fabrication of waveguides can include the use of material systems that allow for the recording of holographic optical elements within the waveguides. One class of such material includes polymer dispersed liquid crystal (“PDLC”) mixtures, which are mixtures containing photopolymerizable monomers and liquid crystals. A further subclass of such mixtures includes holographic polymer dispersed liquid crystal (“HPDLC”) mixtures. Holographic optical elements, such as volume phase gratings, can be recorded in such a liquid mixture by illuminating the material with two mutually coherent laser beams. During the recording process, the monomers polymerize and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (“AR”) and virtual reality (“VR”), compact heads-up displays (“HUDs”) for aviation and road transport, and sensors for biometric and laser radar (“LIDAR”) applications.

### SUMMARY OF THE INVENTION

Systems and methods for holographic waveguide illumination homogenizers in accordance with various embodiments of the invention are illustrated. One embodiment includes an illumination device that includes a laser source emitting light of at least a first wavelength, a microdisplay, a projection lens, and at least one waveguide substrate, each said substrate supporting at least one input grating for coupling light from said laser into a total internal reflection path in said substrate, a grating device for despeckling said light, at least one beam splitter layer, and at least one output grating for extracting light from said substrate, wherein said output grating is configured to perform at least of one function selected from the group of: applying diffusing said light into a ray distribution matched to the numerical aperture of said projection lens, extracting light from said waveguide substrate towards a reflective surface of said microdisplay, and transmitting image modulated light reflected from said microdisplay into said projection lens for display.

In another embodiment, said grating device for despeckling said light includes at least one array of selectively switchable grating elements disposed in at least one layer.

In a further embodiment, said at least one layer forms a stack.

In still another embodiment, each grating element is configured to perform at least one function selected from the group of: beam deflection, diffusion, and phase retardation across the wavefronts of said TIR light.

In a still further embodiment, each said waveguide substrate transmits light of a unique wavelength band.

In yet another embodiment, an input grating supported by said waveguide substrate is switched into a diffracting state when light of said unique wavelength band is emitted by said laser source.

In a yet further embodiment, an output grating supported by said waveguide substrate is switched into a diffracting state when light of said unique wavelength band is emitted by said laser source.

In another additional embodiment, at least one of said input and output gratings has at least one characteristic selected from the group of: a switchable grating, a rolled K-vector vector, spatially varying refractive index modulation, and spatially varying grating thickness.

In a further additional embodiment, said input and output gratings are switchable Bragg gratings.

Another embodiment again includes an illumination device that includes a laser source emitting light of at least a first wavelength, a light modulator, a dynamic micromirror device including at least one electro-mechanically rotatable mirror for reflecting incident collimated light modulated with image data by said light modulator into directions within a field of view, and at least one waveguide substrate with a first and second total internal reflection surface, each said substrate supporting at least one input grating for coupling light of a first polarization from said laser into a total internal reflection path in said substrate and at least one switchable grating beam splitter for diffracting said first polarization light through said first surface onto said dynamic micromirror device and receiving light of a second polarization reflected from said dynamic micromirror device and transmitting it through a second surface of the waveguide.

In a further embodiment again, the illumination device further includes a projection lens in the optical path of said light transmitted through said second surface.

In still yet another embodiment, the illumination device further includes a waveguide grating device for despeckling said light disposed between said laser source and said switchable grating beamsplitter.

In a still yet further embodiment, said switchable grating beamsplitter is configured to perform at least of one function selected from the group of: applying diffusing said light into a ray distribution matched to the numerical aperture of said projection lens, extracting light from said waveguide substrate towards a reflective surface of a microdisplay, and transmitting image modulated light reflected from said microdisplay into said projection lens for display.

In still another additional embodiment, at least one of said gratings has at least one characteristic selected from the group of: a switchable grating, a rolled K-vector vector, spatially varying refractive index modulation, and spatially varying grating thickness.

In a still further additional embodiment, said gratings are switchable Bragg gratings.

In still another embodiment again, each said waveguide substrate transmits light of a unique wavelength band.

In a still further embodiment again, an input grating supported by said waveguide substrate is switched into a diffracting state when light of said unique wavelength is emitted by said laser source.

In yet another additional embodiment, said switchable grating beam splitter is switched into a diffracting state when light of said unique wavelength is emitted by said laser source.

In a yet further additional embodiment, said dynamic micromirror device is a m icro-electro-mechanical system.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 conceptually illustrates a monochromatic waveguide homogenizer in accordance with an embodiment of the invention.

FIG. 2 conceptually illustrates a color waveguide homogenizer in plan and side elevation views in accordance with an embodiment of the invention.

FIG. 3 conceptually illustrates a color waveguide homogenizer in plan and side elevation views in accordance with an embodiment of the invention.

FIG. 4 conceptually illustrates a monochrome waveguide homogenizer in side elevation view in accordance with an embodiment of the invention.

FIG. 5 conceptually illustrates a color waveguide homogenizer in side elevation view in accordance with an embodiment of the invention.

FIG. 6 conceptually illustrates a monochrome waveguide homogenizer for use with a laser-scanned display in side elevation view in accordance with an embodiment of the invention.

FIG. 7 conceptually illustrates a monochrome waveguide homogenizer for use with a laser-scanned display in side elevation view in accordance with an embodiment of the invention.

FIGS. 8A-8D conceptually illustrate different projection views of a waveguide laser scanned display incorporating the waveguide homogenizer of FIG. 6 in accordance with an embodiment of the invention.

FIG. 9 conceptually illustrates a waveguide homogenizer in side elevation view in accordance with an embodiment of the invention.

FIG. 10 conceptually illustrates a waveguide homogenizer in a three-dimensional view in accordance with an embodiment of the invention.

FIGS. 11A-11D conceptually illustrate the principles of operation of a portion of an SBG array despeckler stack in accordance with an embodiment of the invention.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating comprised of a set of gratings in some embodiments. For illustrative purposes, it is to be understood that the drawings are not drawn to scale unless stated otherwise.

The competitive advantage of laser-illuminated waveguide displays result from increased lifetime, lower cost, higher brightness, and improved color gamut. Although lasers offer much more compact illumination solutions than can be provided with conventional sources such as LEDs, the demand for yet more compressed form factors continues unabated. Classical illumination designs using beam splitters and combiners fail to meet the requirements. Laser displays suffer from speckle, a sparkly or granular structure seen in uniformly illuminated rough surfaces. Speckle, which can arise from the high spatial and temporal coherence of lasers, reduces image sharpness and is distracting to the viewer. Several approaches for reducing speckle contrast have been proposed based on spatial and temporal decorrelation of speckle patterns. Laser waveguide displays also exhibit a non-uniformity called “banding” resulting from gaps or overlaps in the waveguide beams, which can lead to visible gaps or illumination ripples in the illumination extracted from the waveguide. As such, many embodiments of the invention are directed towards compact and efficient waveguide homogenizers for providing uniform illumination to microdisplays for projection and waveguide displays incorporating such waveguide homogenizers providing uniform illumination to microdisplays used as an image source for the waveguide displays. Various embodiments of the invention are also directed towards waveguide homogenizers for despeckling and homogenizing illumination in laser scanned waveguide displays.

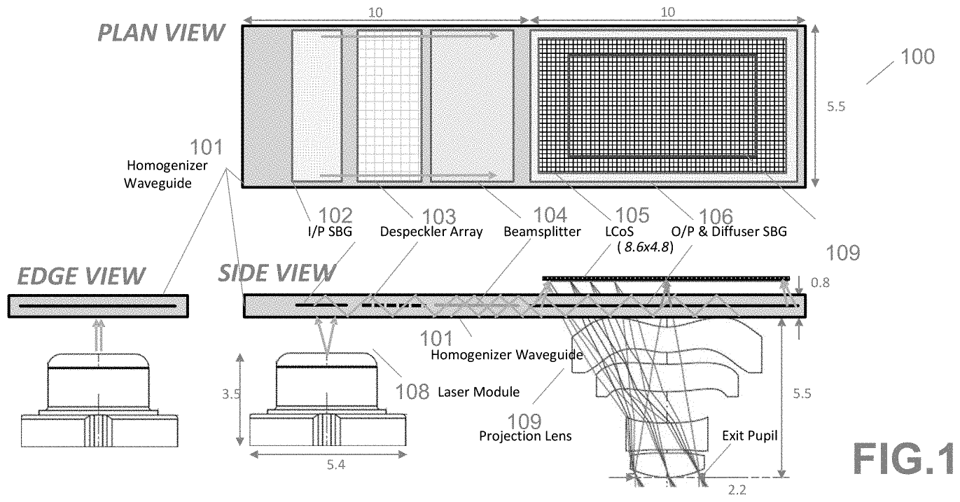

Turning now to the drawings, waveguide devices for homogenizing laser illumination in accordance with various embodiments are illustrated. FIG. 1 conceptually illustrates a monochromatic waveguide homogenizer 100 in accordance with an embodiment of the invention. In the illustrative embodiment, the homogenizer 100 includes a waveguide 101 supporting an input grating 102, a despeckler array device 103 that includes at least one layer of selectively switchable grating elements, at least one beamsplitter layer 104, and an output grating 106, which can provide beam expansion across the reflecting surface of a microdisplay panel 105. The beamsplitter layers can include a partially transmitting coating that can create multiple internal reflection paths between the beamsplitter layers and the waveguide surfaces, thereby providing beam homogenization. After reflection at the microdisplay, the image modulated light can be transmitted through the output grating onto the projection lens 109, which collimates the light over a field of view. The apparatus further includes a laser module 108 providing narrow band illumination. In some embodiments, the waveguide homogenizer operates in the green band. As will be discussed below, the based architecture can be extended to provide full color operation. In many embodiments, the gratings are switchable Bragg gratings (SBGs). In some embodiments, the output grating can also incorporate a light diffusing function designed to form uniform illumination for illuminating the microdisplay panel. In some embodiments, the output grating can be non-diffusing with the required diffusion being provide by one or more diffusing surface supported by the waveguide and disposed along the TIR path. In some embodiments, the output grating contains rolled K vectors (grating vectors), that is, the K-vector direction varies along the grating. The rolled K-vectors can be used to vary the average direction of the rays scattered from a point on the grating. In many embodiments, the scattered rays can be characterized by a diffusion cone with an axis that can be tilted at different angles using the rolled K-vectors. In many embodiments, the divergence angle of the diffusion cones can also be varied across the output grating by varying the diffusion prescription of the grating. The diffusion prescription can depend on local grating non-uniformities and/or material properties. In some embodiments, the diffusion characteristics can be provided by additives introduced during the deposition of the holographic recording material using an inkjet printing process. In some embodiments, the output grating is a computer-generated hologram. By matching the diffusion characteristic to the spatially varying numerical aperture (NA) of the projection lens at the microdisplay, the output grating can enable efficient use of available light while reducing stray light, which can reduce image contrast. In some embodiments, the output grating can be partitioned into a plurality of bands each characterized by a unique grating characteristic such as but not limited to a K-vector or index modulation.

In the embodiments to be described, the SBG despeckler array device includes at least one layer of switching SBG elements. In some embodiments, the SBG despeckler array can include a stack including layers of switching grating arrays. In some embodiments, the stack can include arrays of non-switching grating elements. In some embodiments, the grating elements can be planar gratings. In some embodiments, the grating elements have at least one characteristic selected from the set of optical power, diffusion, and phase retardation. The input grating and output gratings may be passive or switching. In color waveguide homogenizers, it can be advantageous for at least one of the input grating and output grating to switch to enable color sequential switching. Gratings for use with the invention can have properties including at least one selected from the set of rolled K-vectors, spatially varying refractive index modulation, spatially varying refractive index, and spatially varying grating thickness. In some embodiments where multiple gratings are incorporated, two or more gratings can be multiplexed into a single grating layer. In further embodiments, the multiplexed gratings are in different layers.

In many embodiments, the microdisplay can be a liquid crystal on Silicon (LCoS) device. In some embodiments, the microdisplay can be a MEMS device such as the Digital Light Projector (DLP) manufactured by Texas Instruments (Texas). An exemplary LCoS device is the OmniVision OP02220, which can provide 1080p resolution (i.e. a native resolution of 1920×1080 pixels) at 60 fps; a pixel pitch of 4.5-micrometers, and an active area of 8.64 mm.×4.86 mm. (9.91 mm./0.39″ diagonal.). As will be discussed below, the invention can also be applied to a laser projector device. In some embodiments, the reflective microdisplay shown in FIG. 1 can be replaced by a transmissive microdisplay. In the case of a reflective microdisplay, the embodiments of FIG. 1 can offer the advantage that the need for a beamsplitter (normally a polarization beamsplitter cube) is eliminated by the polarization selective properties of SBGs. As shown in FIG. 1, TIR light, which is preferentially P-polarized for maximum diffraction efficiency by the SBGs, can be reflected from the microdisplay with its polarization rotated to S-polarization. Since the output SBG has low diffractive efficiency for S-polarized light, the reflected light can propagate through the waveguide with substantial deviation or loss. The projection lens then forms a collimated beam, which can be projected for viewing on a screen in some embodiments. In many embodiments, the image modulated light can be coupled into a display waveguide (as disclosed in the references), which typically performs two-dimensional pupil expansion to provide a large eyebox. Typical dimensions of the key components of the homogenizer waveguide are indicated in FIG. 1. Typically, the waveguide is 20 mm in length, 5.5 mm in width, and less than 1 mm thick. The projection lens can be based on a miniature multi element design such as the ones commonly used in smart phone cameras. Many examples of suitable lens designs may be found in the patent literature. For example, U.S. Pat. No. 7,643,225 discloses a F/2.8-F/3.67 lens with a total field of 66 degrees that can, with suitable scaling, be used in the present invention. Another reference: U.S. Pat. No. 6,844,989, discloses a F/2.8-F/4.1 lens with a total field of 62 degrees. In some embodiments, the lens should be capable of imaging a 35-deg.×35-deg. field of view at F/4.0-F/5.0. In some embodiments, the lens can include aspheric surfaces and DOE surfaces for color correction and form factor reduction. In some embodiments, the lens can employ one or more elements fabricated from optical plastic to reduce cost and weight.

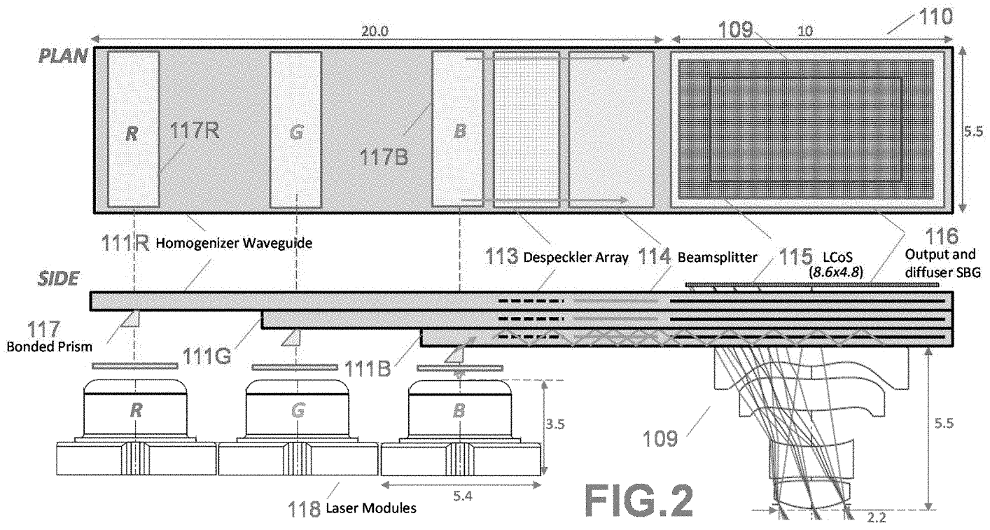

FIG. 2 conceptually illustrates a color waveguide homogenizer 110 in plan and side elevation views in accordance with an embodiment of the invention. In the illustrative embodiment, the apparatus includes a homogenizer waveguide including red, green, and blue layers 111R,111G,111B each supporting input coupling prisms 117 bonded to the waveguide surface, a SBG despeckler array 113, a beamsplitter 114, and an output diffuser SBG 116. The input light can be provided by red, green, and blue laser modules 118. Approximate component dimensions are indicated. The waveguide layers can be switched color sequentially to overcome color crosstalk between the waveguides. In many embodiments directed at color illumination, the output gratings are switchable. In many embodiments directed at color illumination, a waveguide layer may propagate more than one laser wavelength. For example, in many embodiments, a waveguide homogenizer can include a first waveguide layer for homogenizing blue and green laser wavelengths and a second layer for homogenizing light of green and red wavelengths. In many embodiments, a color illumination homogenizer may include a single waveguide layer for propagating red, green, and blue wavelengths. In some embodiments, a single layer homogenizer waveguide may propagate one blue wavelength, two green wavelengths and one red wavelength. In many embodiments, the selection of wavelengths can be determined by consideration of light efficiency and color gamut.

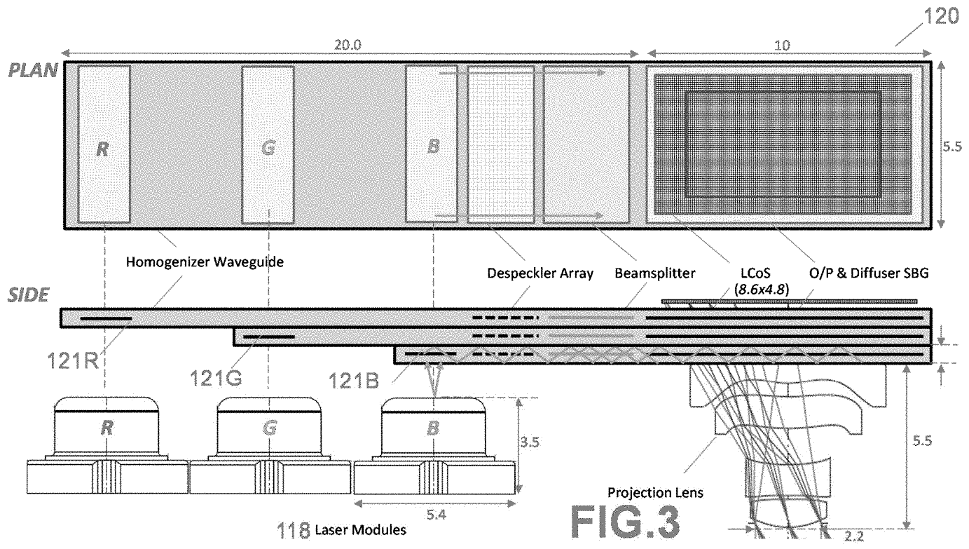

FIG. 3 conceptually illustrates a color waveguide homogenizer 120 in plan and side elevation views in accordance with an embodiment of the invention. The optical layout is similar to that of FIG. 2 with the input coupling prism replaced by the red, green, and blue input gratings 121R,121G,121B which are also labelled by symbols R,G,B. Approximate component dimensions are indicated for illustrative purposes.

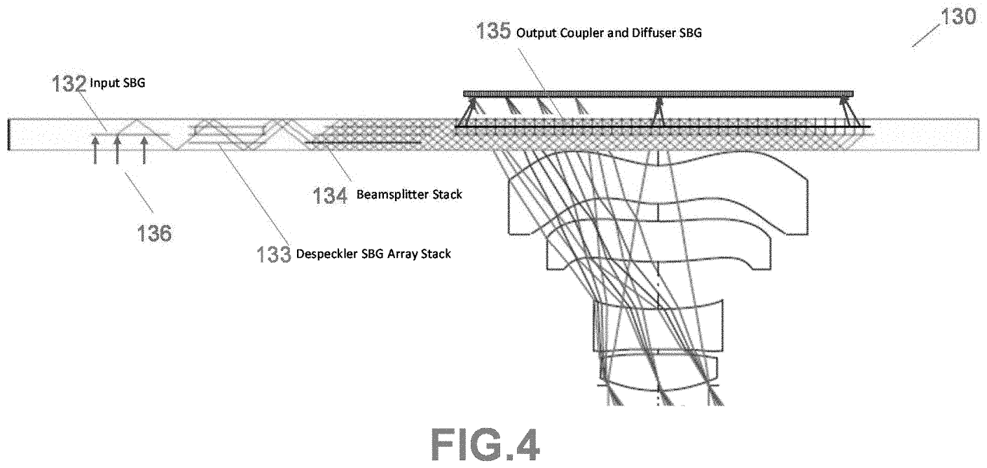

FIG. 4 conceptually illustrates a monochrome waveguide homogenizer 130 in side elevation view in accordance with an embodiment of the invention. As shown, the waveguide supports an input grating 132, a stack of three despeckler SBG arrays 133, a stack of three beamsplitters 134, and a single output SBG 135.

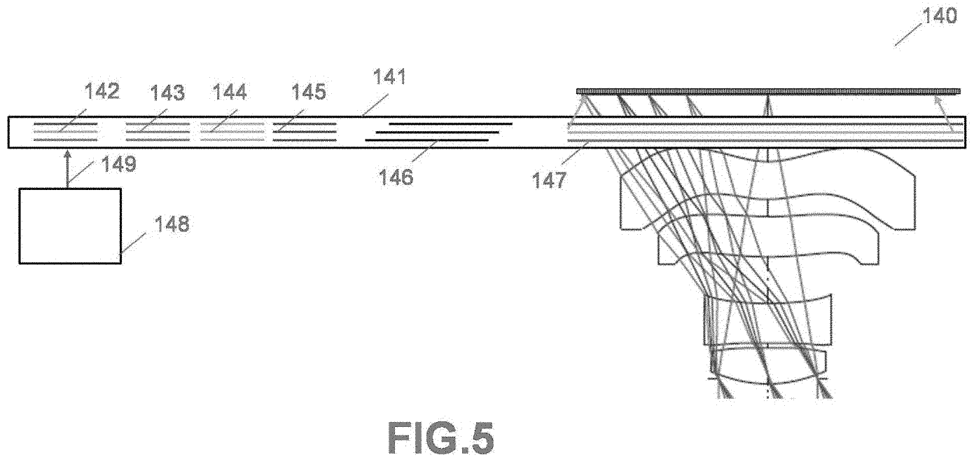

FIG. 5 conceptually illustrates a color waveguide homogenizer 140 in side elevation view in accordance with an embodiment of the invention. In the illustrative embodiment, the apparatus includes a waveguide 141 containing an input grating stack 142 that includes red, green, and blue diffracting SBGs, a red diffracting stack of SBG despeckler arrays 143, a green diffracting stack of SBG despeckler arrays 144, a blue diffracting stack of SBG despeckler arrays 145, a stack of beam splitters 146, and a stack of output SBGs 147. The apparatus further includes a laser module 148 emitting red, green, and blue light generally indicated by 149. The input gratings may encode optical function for anamorphic beam shaping and collimation.

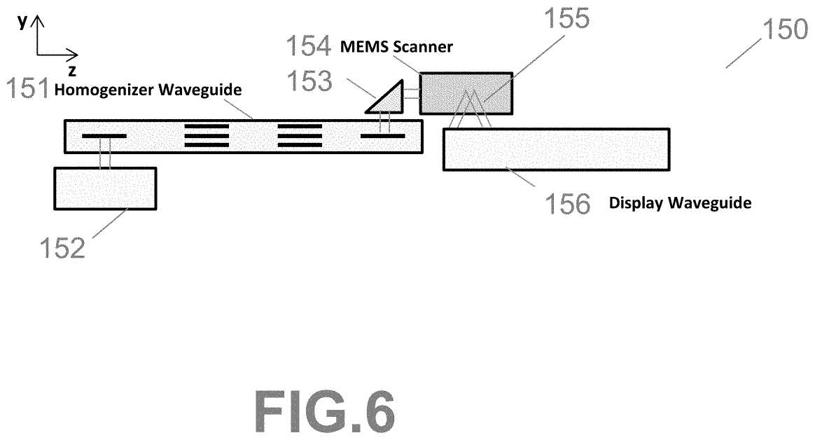

FIG. 6 conceptually illustrates a monochrome waveguide homogenizer for use with a laser-scanned display in side elevation view in accordance with an embodiment of the invention. In the illustrative embodiment, the apparatus 150 includes a waveguide homogenizer 151 according to the principles discussed above coupled to a laser module 152. The output light from the output grating diffuser is deflected by the prism (or mirror) 153 onto a MEMs scanner 154 (including a video modulator) which produces the angle scanned image modulated output beam 155 which can be coupled into the display waveguide 156. The display waveguide can be based on any of the waveguide display designs disclosed in the reference documents. In many embodiments, laser light is scanned in at least one angular direction using an electro mechanical beam deflector. In some embodiments, the laser scanner can be an electro optical device.

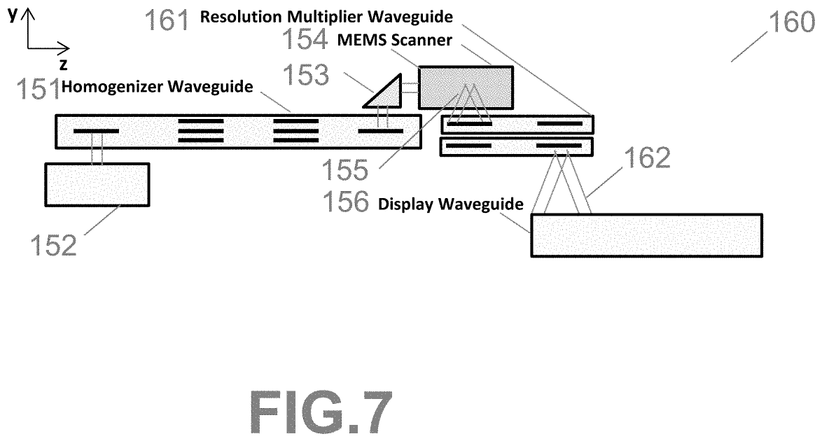

FIG. 7 conceptually illustrates a monochrome waveguide homogenizer 160 for use with a laser-scanned display in side elevation view in accordance with an embodiment of the invention. The apparatus is similar to that of FIG. 6 and further includes a resolution multiplication waveguide 161 as disclosed in U.S. patent application Ser. No. 16/162,280 entitled SYSTEMS AND METHODS FOR MULTIPLYING THE MAGE RESOLUTION OF A PIXELATED DISPLAY, which increases the resolution of the scanned light in at least one of the horizontal and vertical directions to provide an output beam 162 for coupling into the display waveguide 156. An exemplary MEMS laser scanner is supplied by ST Microelectronics (IGeneva).

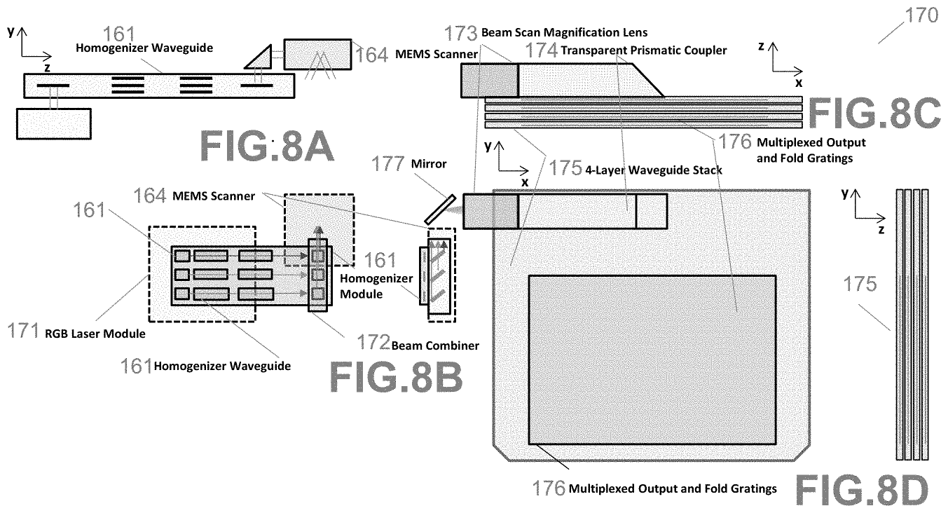

FIGS. 8A-8D conceptually illustrate different projection views of a waveguide laser scanned display 170 incorporating the waveguide homogenizer of FIG. 6 in accordance with an embodiment of the invention. FIG. 8A is a side elevation view of a homogenizer waveguide 161 coupled to a laser scanner 164 and a resolution multiplying waveguide 165. FIG. 8B is a schematic plan view showing the layout of the homogenizer waveguide in more detail. Red, green, and blue grating groups, each including an input SBG (overlaying a red, green, and blue emitting laser module 171), a despeckler SBG array, a beamsplitter, and output gratings are disposed in parallel trains leading to a beam combiner 172. In many embodiments, the beam combiner includes a dichroic beamsplitter tilted at 45 degrees to the z-axis shown in the drawing and arranged along an axis orthogonal to the homogenizer waveguide propagation direction (y direction). As shown in FIG. 8C and FIG. 8D, the combined beams are coupled into the MEMs scanner (including a video modulator, which is not shown). In many embodiments, the output light from the MEMS scanner can have its scan angle magnified by the beam scan magnification lens 173 before being coupled into the display waveguide 175. In some embodiments, the waveguide supports a waveguide structure 176 including at least one multiplexed output and fold grating.

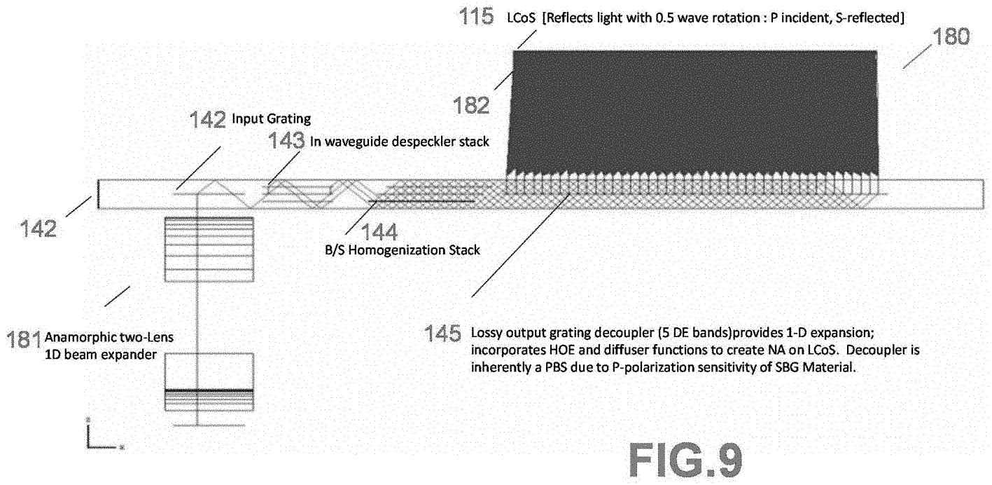

FIG. 9 conceptually illustrates a waveguide homogenizer 180 in side elevation view in accordance with an embodiment of the invention. In addition to the previously discussed components, the apparatus further includes a two-lens anamorphic one-dimensional beam expander generally indicated by numeral 181. The homogenized output beam from the waveguide is indicated by numeral 182.

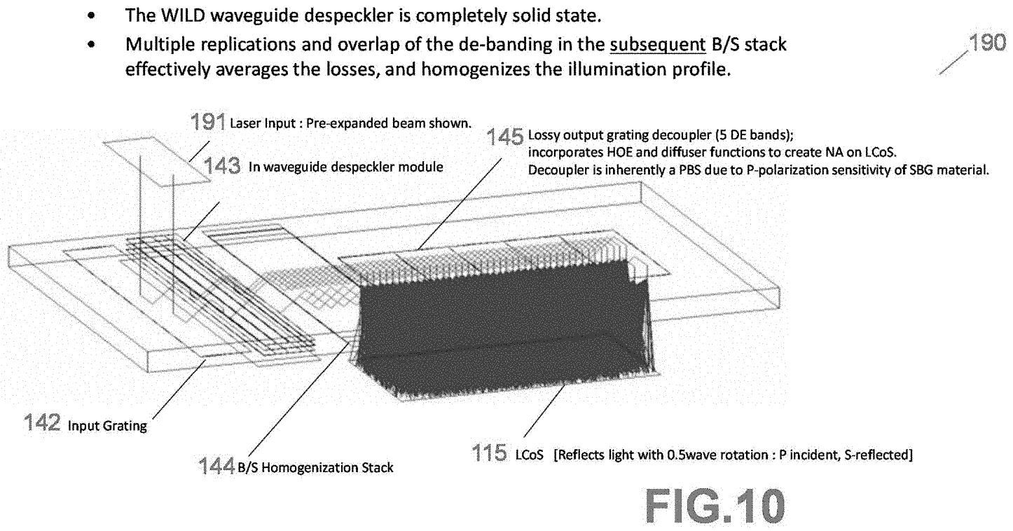

FIG. 10 conceptually illustrates a waveguide homogenizer 190 in a three-dimensional view in accordance with an embodiment of the invention. The pre-expanded beam from the laser module is indicated by numeral 191.

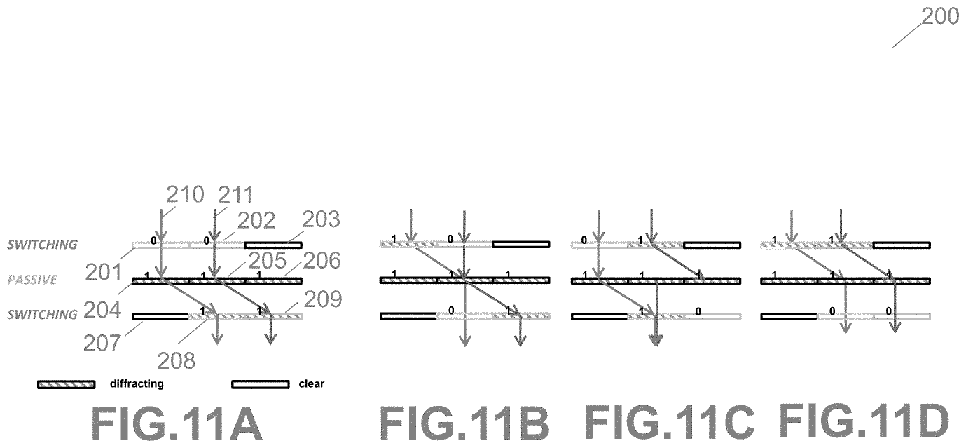

FIGS. 11A-11D conceptually illustrate the principles of operation of a portion of an SBG array despeckler stack in accordance with an embodiment of the invention. The despeckler region has three SBG layers each containing three elements. Only two layers, the upper layer including the elements 201-203 and the lower layer including the elements 207-209, can be required to switch. Only one drive signal and an inverse function can be required. The center layer including the elements 204-206 can be a passive (non-switching) diffractive layer. Each of FIGS. 11A-11D shows a unique state of the despeckler stack portion with gratings in a diffractive state drawn with hatched fill and gratings in a non-diffractive state drawn with clear fill. In the illustrative embodiment, all of the gratings diffract at the same angle. Hence, each of the switching layers is the inverse of the other, that is, the top layer and bottom layer matched cells have symmetric K-vectors. As shown in FIGS. 11A-11D, there are therefore two paths for any one given unit cell (or two modes per pixel for averaging speckle). Hence, for N columns there are 2N modes (i.e., 2²=4 modes). A 30-column device would provide 2³⁰ possible modes.

The invention offers several benefits in the field of illumination system for displays, including high brightness, efficiency, low etendue, compact form factor, and excellent color gamut. The output grating of a waveguide homogenizer according to the principles of the invention can provide compact beam splitting (replacing bulky cube prisms). The output grating can also encode diffusion ray geometries tailored to the NA of the projection lens allowing better utilization of light and more compact lens forms with fewer lens elements. The homogenizer waveguide can have full switching capability to enable color sequential operation compactly and without cross talk. The waveguide homogenizers can employ active despeckling and homogenization in a compact transparent structure with no moving parts. The grating properties (index modulation, average index, and K-vector) can be fine-tuned spatially for high brightness and uniformity. The waveguide homogenizer can enable very efficient use of light since the despeckling and beam-splitting stages incur little light loss.

An important factor to be addressed in waveguide displays and illumination devices, particularly those using lasers, results from beam edge mismatching as a beam undergoes TIR. For a waveguide of thickness D, distance between successive beam-surface interactions W, and a TIR angle U, the condition for seamless matching of upward and downward going TIR beams can be given by the equation 2D tan(U)=W. When this condition is not met, gaps or overlaps between adjacent beam portions can occur, which result in a non-uniformity in the output illumination called banding. Banding is alleviated to some extent by using broadband sources such as LEDs. However, the effect is much more difficult to overcome with lasers. In many embodiments, the waveguide backlight can be configured to operate entirely in collimated space. In other words, the input light and the output beams replicated at each beam grating interaction are all collimated. In many embodiments, the input beam is scanned in at least one angular direction. In some embodiments, the cross section of the input beam can be varied with incidence angle to match a debanding condition according to the embodiments or teaching disclosed in U.S. Provisional Patent Application No. 62/497,781 entitled APPARATUS FOR HOMOGENIZING THE OUTPUT FROM A WAVEGUIDE DEVICE, filed on 2 Dec. 2016. In some embodiments, the input beam cross section can be adjusted by means of edges formed on a surface or layer supported by the waveguide as discussed in the above references. The present invention can incorporate many of the features and teaching discloses in the above references. The present invention can also incorporate features and disclosed in U.S. Provisional Patent Application No. 62/643,977 entitled HOLOGRAPHIC WAVEGUIDES INCORPORATING BIREFRINGENCE CONTROL AND METHODS FOR THEIR FABRICATION, filed on 16 Mar. 2018.

In many embodiments, light is coupled into the waveguide using a grating or a prism. In many embodiments, the optics for coupling light into the waveguides may further include one or more of the following: beam splitters, filters, dichroic filters, polarization components, light integrators, condenser lenses, micro lenses, beam-shaping elements, and other components commonly used in display illumination systems. For example, some embodiments include an input grating for coupling light of a first polarization into the waveguide. Several embodiments include micromirrors capable of reflecting light of a second polarization into the waveguide.

In many embodiments, the grating includes at least one selected from the group of a planar grating, a grating with optical power, a grating providing optical retardation, and a grating with diffusing properties. In many embodiments, the grating elements can have spatially varying diffraction efficiencies to enable extraction of light along the waveguide. In many embodiments, the grating elements have diffraction efficiencies proportional to voltages applied across the electrodes. In some embodiments, the grating elements can have phase retardations proportional to voltages applied across said electrodes. In many embodiments, the grating elements can be configured as a one-dimensional array of elongate elements. In many embodiments, the gratings can be configured as two-dimensional arrays. In many embodiments, the gratings elements are recorded in a Holographic Polymer Dispersed Liquid Crystal. In many embodiments, the spatio-temporal addressing of grating elements by an electrical control circuit can be characterized by a cyclic process. In many embodiments, the spatio-temporal addressing of grating elements by an electrical control circuit can be characterized by a random process.

The embodiments and teachings disclosed herein can be used in many display applications including LCD monitors, digital holographic display, HUDs, and displays for use in mobile computing and telecommunications devices.

This application is related to the following patents and patent applications: U.S. Pat. No. 8,224,133 filed on 17 Jul. 2012 entitled LASER ILLUMINATION DEVICE, which claims the benefit of U.S. Provisional Patent Application No. 60/935,109 filed on 26 Jul. 2007; U.S. Pat. No. 9,274,349 filed on 1 Mar. 2016 entitled LASER DESPECKLER BASED ON ANGULAR DIVERSITY, which claims benefit of U.S. Provisional Application No. 61/457,482 filed on 7 Apr. 2011; U.S. patent application Ser. No. 15/502,583 filed on 8 Feb. 2017 entitled WAVEGUIDE LASER ILLUMINATOR INCORPORATING A DESPECKLER, which claims benefit of U.S. Provisional Patent Application No. 61/999,866 filed on 8 Aug. 2014.

This application is also related to the following patents and patent applications: U.S. Provisional Patent Application No. 62/806,665 filed on 15 Feb. 2019 entitled METHODS AND APPARATUSES FOR PROVIDING A COLOR HOLOGRAPHIC WAVEGUIDE DISPLAY; U.S. Provisional Patent Application No. 62/813,373 filed on 4 Mar. 2019 entitled METHODS AND APPARATUSES FOR PROVIDING A COLOR HOLOGRAPHIC WAVEGUIDE DISPLAY; U.S. patent application Ser. No. 16/162,280 filed on 16 Oct. 2017 entitled SYSTEMS AND METHODS FOR MULTIPLYING THE IMAGE RESOLUTION OF A PIXELATED DISPLAY; U.S. Provisional Patent Application No. 62/497,781 filed on 2 Dec. 2016 entitled APPARATUS FOR HOMOGENIZING THE OUTPUT FROM A WAVEGUIDE DEVICE; U.S. Provisional Patent Application No. 62/792,309 filed on 14 Jan. 2019 entitled HOLOGRAPHIC WAVEGUIDE DISPLAY WITH LIGHT CONTROL LAYER; U.S. Provisional Patent Application No. 62/643,977 filed on 16 Mar. 2018 entitled HOLOGRAPHIC WAVEGUIDES INCORPORATING BIREFRINGENCE CONTROL AND METHODS FOR THEIR FABRICATION.

The disclosures of U.S. Pat. Nos. 8,224,133 and 9,274,349 are hereby incorporated by reference in their entireties for all purposes. The disclosures of U.S. patent application Ser. Nos. 15/502,583 and 16/162,280 are hereby incorporated by reference in their entireties for all purposes. The disclosures of U.S. Provisional Patent Application Nos. 60/935,109, 61/457,482, 61/999,866, 62/806,665, 62/813,373, 62/497,781, 62/792,309, and 62/643,977 are hereby incorporated by reference in their entireties for all purposes.

The construction and arrangement of the systems and methods as shown in the various exemplary embodiments are illustrative only. Although some of the FIGS. provide exact dimensions, it is to be understood that such dimensions are provided for illustrative purposes only. Various embodiments with different dimensions can be implemented as appropriate depending on the specific requirements of the given application. Although only a few embodiments have been described in detail in this disclosure, many modifications are possible (variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. An illumination device comprising:
a laser source emitting light of at least a first wavelength;
a microdisplay;
a projection lens; and
at least one waveguide substrate, each said substrate supporting:
at least one input grating for coupling light from said laser into a total internal reflection path in said substrate;
a grating device for despeckling said light;
at least one beam splitter layer; and
at least one output grating for extracting light from said substrate, wherein said output grating is configured to perform at least of one function selected from the group of: diffusing said light into a ray distribution matched to the numerical aperture of said projection lens, extracting light from said waveguide substrate towards a reflective surface of said microdisplay, and transmitting image modulated light reflected from said microdisplay into said projection lens for display.

2. The illumination device of claim 1, wherein said grating device for despeckling said light comprises at least one array of selectively switchable grating elements disposed in at least one layer.

3. The illumination device of claim 2, wherein said grating device for despeckling said light further comprises at least one array of non-switching grating elements disposed in at least one layer.

4. The illumination device of claim 2, wherein said at least one layer forms a stack.

5. The illumination device of claim 2, wherein each grating element is configured to perform at least one function selected from the group of: beam deflection, diffusion, and phase retardation across the wavefronts of said TIR light.

6. The illumination device of claim 1, wherein each said waveguide substrate transmits light of a unique wavelength band.

7. The illumination device of claim 6, wherein an input grating supported by said waveguide substrate is switched into a diffracting state when light of said unique wavelength band is emitted by said laser source.

8. The illumination device of claim 6, wherein an output grating supported by said waveguide substrate is switched into a diffracting state when light of said unique wavelength band is emitted by said laser source.

9. The illumination device of claim 1, wherein at least one of said input and output gratings has at least one characteristic selected from the group of: a switchable grating, a rolled K-vector vector, spatially varying refractive index modulation, and spatially varying grating thickness.

10. The illumination device of claim 1, wherein said input and output gratings are switchable Bragg gratings.

11. An illumination device comprising:
a laser source emitting light of at least a first wavelength;
a light modulator;
a dynamic micromirror device comprising at least one electro-mechanically rotatable mirror for reflecting incident collimated light modulated with image data by said light modulator into directions within a field of view; and
at least one waveguide substrate with a first and second total internal reflection surface, each said substrate supporting:
at least one input grating for coupling light of a first polarization from said laser into a total internal reflection path in said substrate; and
at least one switchable grating beam splitter for diffracting said first polarization light through said first surface onto said dynamic micromirror device and receiving light of a second polarization reflected from said dynamic micromirror device and transmitting it through a second surface of the waveguide.

12. The illumination device of claim 11, further comprising a projection lens in the optical path of said light transmitted through said second surface.

13. The illumination device of claim 11, further comprising a waveguide grating device for despeckling said light disposed between said laser source and said switchable grating beamsplitter.

14. The illumination device of claim 12, wherein said switchable grating beamsplitter is configured to perform at least of one function selected from the group of: diffusing said light into a ray distribution matched to the numerical aperture of said projection lens, extracting light from said waveguide substrate towards a reflective surface of a microdisplay, and transmitting image modulated light reflected from said microdisplay into said projection lens for display.

15. The illumination device of claim 11, wherein at least one of said gratings has at least one characteristic selected from the group of: a switchable grating, a rolled K-vector vector, spatially varying refractive index modulation, and spatially varying grating thickness.

16. The illumination device of claim 11, wherein said gratings are switchable Bragg gratings.

17. The illumination device of claim 1, wherein each said waveguide substrate transmits light of a unique wavelength band.

18. The illumination device of claim 17, wherein an input grating supported by said waveguide substrate is switched into a diffracting state when light of said unique wavelength is emitted by said laser source.

19. The illumination device of claim 17, wherein said switchable grating beam splitter is switched into a diffracting state when light of said unique wavelength is emitted by said laser source.

20. The illumination device of claim 11, wherein said dynamic micromirror device is a micro-electro-mechanical system.
